(19) United States
(12) Patent Application Publication
(10) Pub. No.: US 2017/0217790 A1
(43) Pub. Date: Aug. 3, 2017

(54) REMOVAL OF CONTAMINANTS FROM A FLUID INVOLVING IN-SITU GENERATION OF ADSORPTION FILTRATION MEDIA OR REACTIVE COMPONENTS

(71) Applicant: HMSolution, Inc., Providence, RI (US)

(72) Inventor: Margaret Lengerich, Koeln (DE)

(21) Appl. No.: 15/492,754

(22) Filed: Apr. 20, 2017

Related U.S. Application Data
(63) Continuation of application No. PCT/US2015/056680, filed on Oct. 21, 2015.
(60) Provisional application No. 62/066,601, filed on Oct. 21, 2014.

(51) Int. Cl. C02F 1/28; C02F 1/52; C02F 1/48; B01F 13/08; B01F 5/10; C02F 1/74; C02F 1/00

(52) U.S. Cl. CPC C02F 1/281; C02F 1/74; C02F 1/5236; C02F 1/001; B01F 13/0809; B01F 5/10; C02F 1/482; C02F 2101/103

(57) ABSTRACT

In one embodiment, a treatment system for removing dissolved contaminants (e.g., arsenic) from a contaminated fluid (e.g., water) utilizes in-situ generation of adsorption filtration media or reactive components. Corrosion materials (e.g., iron oxide complexes) that serve as the adsorption filtration media or reactive components are generated by supplying a flow of contaminated fluid, and injecting air, into a generator vessel containing pieces of an oxidizable source (e.g., zero-valent iron spheres). The pieces of the oxidizable source are agitated to release particulates of corrosion materials from their surface into solution with the contaminated fluid. Simultaneous to the ongoing generation of corrosion materials, dissolved contaminants in the contaminated fluid are adsorbed on the corrosion materials. New particulate compounds generated by adsorption of the dissolved contaminants on the corrosion materials precipitate from the solution, and are filtered out, thereby removing the contaminants, and yielding treated fluid (e.g., potable water).

### RELATED APPLICATIONS

The present application is a continuation of copending PCT Patent Application No. PCT/US2015/056680, which was filed on Oct. 21, 2015, by HMSolution, Inc. for “REMOVAL OF CONTAMINANTS FROM A FLUID INVOLVING IN-SITU GENERATION OF ADSORPTION FILTRATION MEDIA OR REACTIVE COMPONENTS”, which claims priority to U.S. Provisional Application No. 62/066,601 by Margaret Lengerich, filed on Oct. 21, 2014, entitled “IN SITU GENERATION OF FILTERING MEDIA FOR CHEMICAL REMOVAL FROM A CONTAMINATED FLUID”, the contents of both of which are incorporated by reference herein in their entirety.

### BACKGROUND

Technical Field

The present disclosure relates generally to removing contaminants from fluids (e.g., water) and more specifically to techniques for removing contaminants involving in-situ generation of adsorption filtration media or reactive components.

Background Information

While nearly 70 percent of the world is covered by water, less than 2.5 percent of such water is fresh water. Of this freshwater, less than 1 percent is easily accessible, with the vast majority trapped in glaciers and snowfields. As a result, only about 0.007 percent of the planet's water is readily available to satisfy the thirst of 7.125 billion people. Unfortunately, much of the readily available water is contaminated with toxic metals, metalloids, non-metals and inorganic elements that are dangerous to human health. For example, large quantities of water are contaminated with arsenic, which is one of the most toxic metalloids, and represents a threat for human health.

Arsenic, like many other toxic metals, metalloids and non-metals, may be derived from natural and man-made sources. Arsenic may be found in natural geological formations in some parts of the world, for example, as a result of geochemical reactions. Likewise, arsenic may be a byproduct of agricultural and industrial activities, for example, due to leaching of industrial wastewater or the use of pesticides containing arsenic. Arsenic can be found in water in a variety valence states, but the most dangerous for human health are arsenite (As⁺³) and arsenate (As⁺⁵).

Such forms of arsenic are colorless, tasteless and odorless, but can cause severe effects on human health. Daily ingestion in low concentrations can result in cancer, type II diabetes, developmental delays and permanent brain damage in children, vital organ irritations, hyperkeratosis and/or immunodeficiency leading to chronic and acute infections. To prevent such severe effects, arsenic exposure should be limited. The World Health Organization (WHO) suggested a maximum level of arsenic concentration in drinking water of less than 10 parts per billion (ppb). This standard was adopted by the United States (US) Environmental Protection Agency in 2001, and a variety of other countries have followed the WHO's recommendations. For instance, in Chile this exposure limit was adopted in 2005 by the implementation of an official norm NCh409 for drinking water. The WHO, governmental regulatory agencies, and medical professionals worldwide, continue to study the consequences of arsenic-contaminated drinking water on human health. There is mounting evidence that exposure to levels above 2 ppb can cause the full spectrum of health damage.

The severity of arsenic contamination in water varies from region to region around the world. At least seventy countries are significantly affected, including the United States, Chile, Peru, Argentina, India, Bangladesh, China, Thailand, Pakistan, Myanmar, Afghanistan, Cambodia and Vietnam. Bangladesh is generally considered to be one of the most severely affected countries, with many of its inhabitants exposed to concentrations as high as 1,200 ppb in their water. In Bangladesh, at least one study indicates that up to 20 percent of deaths over a 10-year period can be attributed to arsenic exposure.

In the United States, the second largest groundwater well market in the world after India, arsenic has been found in the private wells and public water systems of 41 states. According to a study carried out by the U.S. Geological Survey, 13% percent of private wells show levels of arsenic exceeding the federal standard of a maximum arsenic concentration of 10 ppb. Additionally, according to the EPA's fiscal year 2010 survey, 934 public water systems in 41 states serving 400,000 households still violate the federal standard. Studies indicate that drinking water contaminants, such as arsenic, are linked to millions of instances of illness within the United States each year.

Various technologies have been used in the past to try to remove contaminants (e.g., arsenic or other toxic metal, metalloid and non-metal contaminants) from water. These existing technologies include fixed bed adsorption systems that use filtration media with a high surface area, such as alumina and activated carbon; ion exchange systems that use synthetic resins, flocculation and precipitation; reverse osmosis; and nano-filtration. However, these technologies typically have high operational costs. The high costs are in part due to the need to manually replace saturated filtration media, and/or to add chemicals to remove certain toxic contaminants (e.g., arsenite (As⁺³)) or to increase the life of the filtration media.

The most adopted technology for large-scale water treatment systems geared towards metal, metalloids and non-metals is reverse osmosis. However, this technology generates large amounts of toxic sludge that requires further treatment before disposal, results in high water loss (up to 30% of the feed water), utilizes delicate and problem-prone membranes to retain contaminants, requires the addition of chemicals to remove certain contaminants such as arsenite (As⁺³), and consumes large amounts of electric power resulting in very high operational costs.

The most adopted technologies for medium-scale water treatment systems are fixed-bed adsorption and ion exchange systems. However, these systems also generally have high operational cost, due to a need to frequently replace saturated filtration media and add chemicals. In traditional fixed-bed adsorption systems, filtration media, which generally consists of synthetic resins or granular particles, is manually placed into the system. The filtration media forms a fixed-bed with a finite capacity, which subsequently gets saturated once the adsorbed contaminants have used up the entire available surface area of particles of the media. The filtration media generally must be manually replaced, on average, every 12-24 months, and the cost of this replacement is typically high. In addition, traditional fixed-bed adsorption systems are often sensitive to pH changes. As such, they may require chemicals to stabilize the pH in order to prolong the life of the filtration media.

In ion exchange systems, the resin employed may be deactivated over time. Some ion exchange systems require a chemical flush every 2 or 3 days, using salt and/or potassium permanganate, to regenerate the resin and allow for new active places in its surface. Other ion exchange systems do not require regeneration, however their costs to replace resins may be quite high. In both fixed-bed adsorption systems and ion exchange systems, chemicals (e.g., chlorine or hypochlorite) generally must be added in order to remove certain contaminants, such as arsenite (As⁺³).

Finally, the most adopted technologies for small-scale water treatment systems, such as those used by private wells owners, are small-scale reverse osmosis and adsorption systems. The operational disadvantages of these small-scale systems are similar to those of the large and medium-scale systems discussed above.

Attempts have been made to improve upon traditional fixed-bed adsorption, ion exchange, reverse osmosis and other prevalent types of water treatment systems. Some of these attempts involve the use of ferrous and ferric oxides, hydroxides and oxi-hydroxides, including lepidocrocite, magnetite, hematite, and bernalita, among other intermediate products produced as a result of corrosion of a metal (e.g., iron), collectively referred to herein as “corrosion materials.” Certain contaminants, such as arsenic ions, can be removed from water through adsorption, co-precipitation and complexity of the surface with corrosion materials. Once the contaminants have been fixed to the active sites of the corrosion materials, it is unlikely desorption will occur and the reaction is irreversible in typical drinking water applications. Reactions R1-R6 listed below represent example processes that may be involved in the formation of corrosion materials from zero-valent iron in neutral pH environments. The formation of ferric ions from zero-valent iron involves two consecutive processes. During the first stage, the iron oxidizes to ferrous iron by heterogeneous reactions, while the second step involves the oxidation of ferrous ions to ferric ions (R4), which can occur through homogeneous and heterogeneous reactions.

Fe(0)+2H₂O→Fe(II)+H₂+2HO⁻ (R1)

Fe(0)+H₂O+½O₂→Fe(II)+2HO⁻ (R2)

Fe(0)+2Fe(III)→3Fe(II) (R3)

Fe(II)+½H₂O+¼O₂→Fe(III)+HO⁻ (R4)

Fe(III)+3H₂O→Fe(HO)₃+3H⁺ (R5)

Fe(II)+CO₃⁻²/HO⁻→ferrous precipitates (R6)

Systems have been proposed that utilize corrosion materials to remove contaminants, however, such systems have suffered a number of different shortcoming that have prevented their widespread adoption. One proposed system simulates a fixed-bed using a mesh fabricated with zero-valent iron, which is inserted inside a tank full of water contaminated with heavy metals like arsenic and selenium. The heavy metals stick to the mesh. Once the surface area of the mesh has been completely saturated by adsorbed metals, it is necessary to manually change it. As such, this type of system requires frequent manual replacement of the mesh, for example, about every 3 to 6 months, which prevents continuous operation and leads to increased cost.

Another proposed system utilizes a hybrid spouted vessel/fixed-bed filter including zero-valent iron particles to remove arsenic. The system operates in a batch mode, which takes 24 hours to drop the arsenic concentration to the standard of 10 ppb, by maintaining the water in solution with the zero-valent iron particles. However, once the system has used all available naturally occurring oxygen in the solution to produce the corrosion material, the arsenic removal performance drops considerably. The use of a batch mode, and the considerable performance drop over time, renders the proposed system unsuited for applications that require continuous treatment and low costs.

In summary, traditional fixed-bed adsorption, ion exchange, reverse osmosis and other prevalent types of water treatment systems generally are costly and difficult to operate and require the addition of chemicals in order to effectively remove arsenite (As⁺³), arsenate (As⁺⁵), and certain other inorganic contaminants from water. Further, previously proposed systems employing corrosion materials have suffered shortcomings, including the need for frequent replacement of media by skilled personnel, the requirement of operation in a batch mode, and decreasing performance over time. There is a need for a cost effective system for removing contaminants (e.g., arsenic, as well as other dissolved metals, metalloids and non-metals contaminants) from a fluid (e.g., water) that may address the shortcomings of the traditional and proposed systems. If such a system were available, it could address long felt needs in urban, rural and mining water supply systems, irrigation systems, wastewater treatment plants, and water purification systems used in the food and beverage industry, among others.

### SUMMARY

Example treatment systems and methods of operation thereof are provided for removing dissolved contaminants (e.g., arsenic, as well as other dissolved metals, metalloids and non-metals contaminants) from contaminated fluid (e.g., contaminated water) involving in-situ generation of adsorption filtration media or reactive components. The adsorption filtration media/reactive components may be corrosion materials (e.g., iron oxide complexes) generated from pieces of an oxidizable source (e.g., zero-valent iron spheres). The treatment system may operate continuously, without addition of chemicals while maintaining a high level of performance

In one embodiment, the corrosion materials (e.g., iron oxide complexes) that serve as adsorption filtration media/reactive components are generated by supplying a flow of contaminated fluid and air (e.g., injected via an air injector) to pieces of the oxidizable source (e.g., zero-valent iron spheres) placed inside a generator vessel, and agitating (e.g., via a magnetic field agitation device, recirculator pump, mechanical agitator and/or fluid flow) the pieces. The pieces of the oxidizable source react upon contact with the contaminated fluid and oxygen molecules from the injected air, generating corrosion materials on the surface of the pieces. The agitation releases particulates of corrosion materials from the surface of the pieces, exposing fresh portions (e.g., fresh zero-valent iron) to continue the oxidation reaction. Simultaneous to the ongoing generation of corrosion materials, the dissolved contaminants in the contaminated fluid are adsorbed on corrosion materials (e.g., within the generator vessel and in a larger mixing vessel). Adsorption may be enhanced by agitating, recirculating, concentrating, inducing velocity gradients and/or mixing the particulates of the corrosion materials and the contaminated fluid (e.g., in the mixing vessel). In some implementations, such operation creates a solution (e.g., a homogenous solution) that increases the chances corrosion materials will meet and adsorb contaminants. Particulate compounds generated by the adsorption of the dissolved contaminates on the corrosion materials precipitate, and are filtered from the solution (e.g., by a cartridge filter system and/or fixed bed system) to remove the contaminants, and yield treated fluid (e.g., potable water).

It should be understood that a variety of additional features and alternative embodiments may be implemented other than those discussed in this Summary. This Summary is intended simply as a brief introduction to the reader, and does not indicate or imply that the examples mentioned herein cover all aspects of the disclosure, or are necessary or essential aspects of the disclosure.

### BRIEF DESCRIPTION OF THE DRAWINGS

The description below refers to the accompanying drawings, of which:

FIG. 1 is a diagram of an example fluid treatment system for removing contaminants (e.g., arsenic as well as other dissolved metals, metalloids and non-metals contaminants) from a fluid (e.g., water) involving in-situ generation of filtration media/reactive components;

FIG. 2 is a graph indicating example amounts of corrosion materials produced from zero-valent iron when varying the content of dissolved oxygen, temperature, and an amount of sodium chloride in solution;

FIG. 3 is a layout diagram of a first embodiment of the example fluid treatment system of FIG. 1;

FIG. 4 is a layout diagram of a second embodiment of the example fluid treatment system of FIG. 1;

FIG. 5 is a layout diagram of a third embodiment of the example fluid treatment system of FIG. 1;

FIG. 6 is a graph showing experimental results of an example laboratory scale test system; and

FIG. 7 is a graph showing experimental results of an example intermediate scale test system.

### DETAILED DESCRIPTION

### Example Embodiments of Deployed Systems

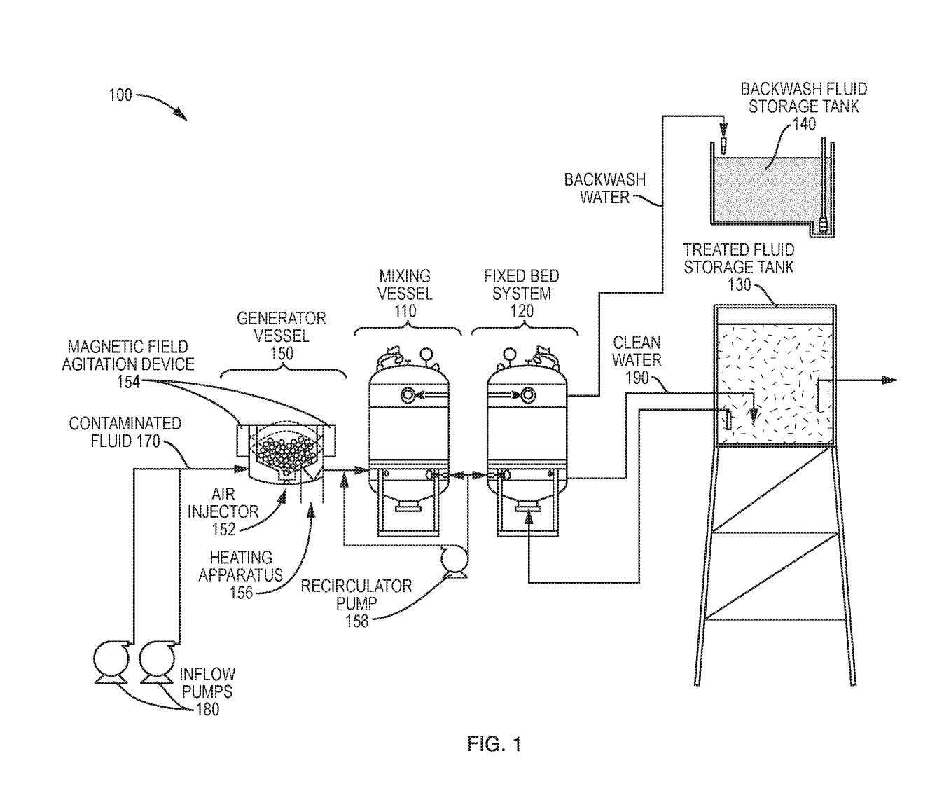

FIG. 1 is a diagram 100 of an example fluid treatment system for removing contaminants (e.g., arsenic, as well as other dissolved metals, metalloids and non-metals contaminants) from a fluid (e.g., water) involving in-situ generation of filtration media/reactive components. The fluid treatment system 100 includes a mixing vessel 110, a fixed bed system 120, a treated fluid storage tank 130, a backwash fluid storage tank 140 and a telemetry control system (not shown). The mixing vessel 110 may include internally, or be coupled to an external generator vessel 150 and a recirculator pump 160. The generator vessel 150 includes an air injector 152, e.g., coupled to a compressor or other source of air (not shown) and a magnetic field agitation device 154. An optional heating apparatus 156 may also be provided.

In operation, contaminated fluid (e.g., contaminated water) 170 is fed to the fluid treatment system 100 via inflow pumps 180. The contaminated fluid flows into the generator vessel 150, which contains an oxidizable source (or sources) that constantly generate corrosion materials that serve as adsorbent filtration media or as reactive components for the system. In the embodiment shown in FIG. 1, the oxidizable source is zero-valent iron spheres, and the corrosion materials are iron oxide complexes, including lepidocrocite, magnetite, green rust, ferrate and bernalite, among other intermediate products produced as a result of corrosion of iron. However, it should be understood that the oxidizable source may alternatively be another material (such as carbon steel, carbon chrome steel, alumina ceramic, etc.) that oxidizes to produce the same, or different, corrosion materials. In the example shown, the generator vessel 150 operates to continuously generate corrosion materials from the oxidizable source because it promotes abrasion between piece (e.g., spheres) of the oxidizable source and supplies sufficient available oxygen. The abrasion is promoted by maximizing contact between the piece of the oxidizable source and agitating the pieces. Sufficient supplies of oxygen are ensured by injecting air into the generator vessel 150 through the air injector 152. The air injector 152 may include an air venturi injector and a diffuser or sparger.

More specifically, in an implementation that uses zero-valent iron spheres and contaminated water, the spheres are oxidized upon contact with the contaminated water and oxygen molecules from the injected air, generating corrosion materials on the surface of the spheres. The magnetic field agitation device 154 generates an intermittent movement of the spheres, while the recirculator pump 158 causes a recirculation flow upward (in opposite direction to gravity). Such operations may cause the spheres to grind against each other and rub against the walls and other internals of the generator vessel 150, releasing particulates of corrosion materials from the surface of the spheres into the contaminated water, and exposing fresh portions of the zero-valent iron. The recirculation flow in the generator vessel 150 may also cause the more buoyant particulates to flow out of the generator vessel 150 into the mixing vessel 110. The air injector 152 ensures sufficient oxygen molecules are available inside in the generator vessel 150 for a stable chemical reaction, so that the when fresh portions of the zero-valent iron spheres are exposed, they rapidly corrode to generate more corrosion material.

The particulates of corrosion materials and contaminated water pass into the mixing vessel 110. Both in the generator vessel 150 and in the larger mixing vessel 110 the corrosion materials operate as an adsorbent filtration media/reactive components, such that contaminants (e.g., arsenic) in the water are adsorbed on, or react with, active sites of the corrosion materials to form new particulate compounds. To promote such action, the particulates of corrosion materials and contaminated water are agitated, recirculated, concentrated and/or mixed, by operation of recirculator pump 158, a mechanical agitator or mixer (not shown), or as a byproduct of velocity gradients, inside the mixing vessel 110. In some implementations, such operation forms a solution (e.g., a homogenous solution) in which the corrosion materials are evenly distributed, to increase the chance that corrosion materials will meet and bond with contaminate particles.

The new compounds precipitate and are dragged by the flow of the fluid into a cartridge filter system and/or a fixed bed system 120. A cartridge filter system may include a sedimentation vessel and granular activated carbon (GAC) cartridge filters, manganese filters, polypropylene microfiber filters, and ceramic filter, among other types of filters. A fixed bed system 120 may include different layers of filtering media, such as manganese dioxide, charcoal, zeolite, and activated carbon, among others, and an automatic backwash system to clean the layers. The automatic backwash system may periodically create a backflow of water (e.g., from a treated fluid storage tank 130), to drag particles deposited in the fixed bed system 120 back to the backwash fluid storage tank 140 or other means of disposal. When not in backflow, clean water 190 flows from the filter bed system 120 to the treated water storage tank 130, to be consumed.

The speed of formation of corrosion materials in the generator vessel 150 from the oxidizable source (e.g., zero-valent iron spheres) is highly dependent on variables such as dissolved oxygen, temperature, agitation and abrasion. As described above, to enable generation of corrosion materials to be fast enough to support continuous operation, supplemental oxygen is supplied by the air injector 152. Further, in some embodiments, supplemental heat is supplied by heating apparatus 156.

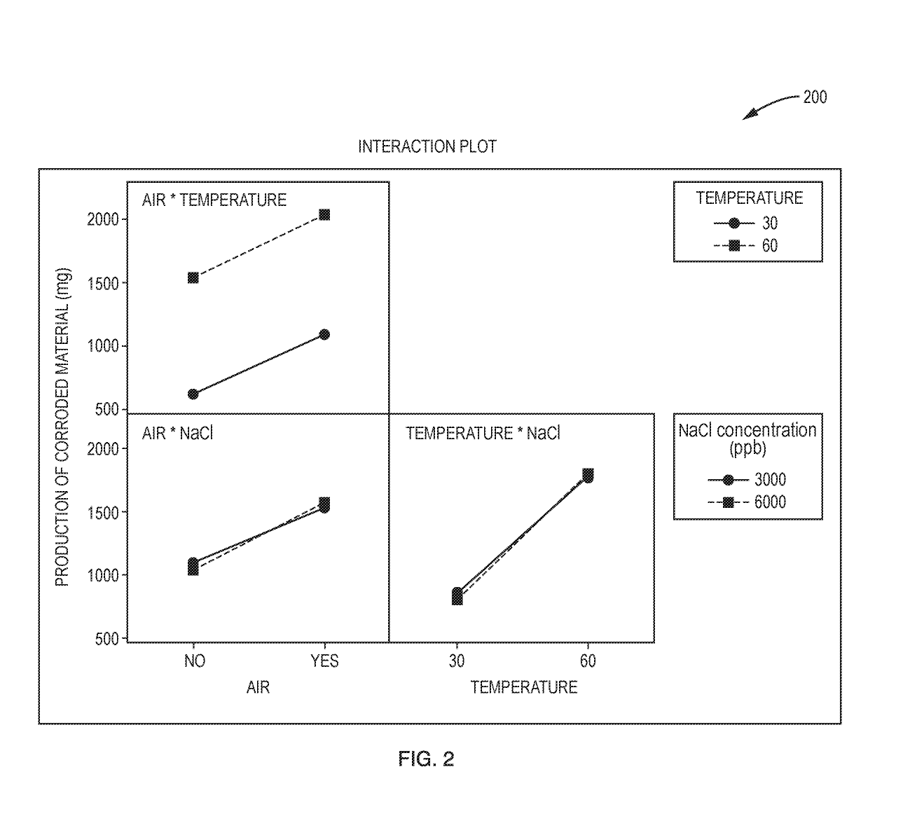

FIG. 2 is a graph 200 indicating example amounts of corrosion materials produced from zero-valent iron when varying the content of dissolved oxygen, temperature, and an amount of sodium chloride in solution. The content of dissolved oxygen determines the nature of the oxides and oxy-hydroxides formed on the surface of zero-valent iron, and the type of the corrosion materials produced. Possible corrosion materials may cover a wide range, but in the presence of oxygen the main products are typically lepidocrocite, magnetite, green rust, ferrate and bernalite; compounds that have demonstrated a high affinity for adsorbing dissolved metals, metalloids and non-metals such as aluminum, arsenate, arsenite, cadmium, cobalt, chromium, copper, mercury, molybdenum, nickel, lead, antimony, selenium, tin, thallium, uranium, zinc, among others.

Corrosion is an electrochemical reaction. Increasing the temperature reduces oxygen solubility, increases the rate of oxygen diffusion to the metal surface, decreases the viscosity of water and increases the solution conductivity. In open systems, in which oxygen can be released from the system, corrosion will increase up to a maximum at 80° C. (175° K) where the oxygen solubility is 3 milligrams per liter (mg/L). Since the diffusion of oxygen to the metal surface has increased, more oxygen is available for the cathodic reduction process thus increasing the corrosion rate. Therefore, the corrosion rate of iron is increased by the increase in temperature by virtue of its effect on the oxygen solubility and oxygen diffusion coefficient. Such effects are demonstrated in FIG. 2.

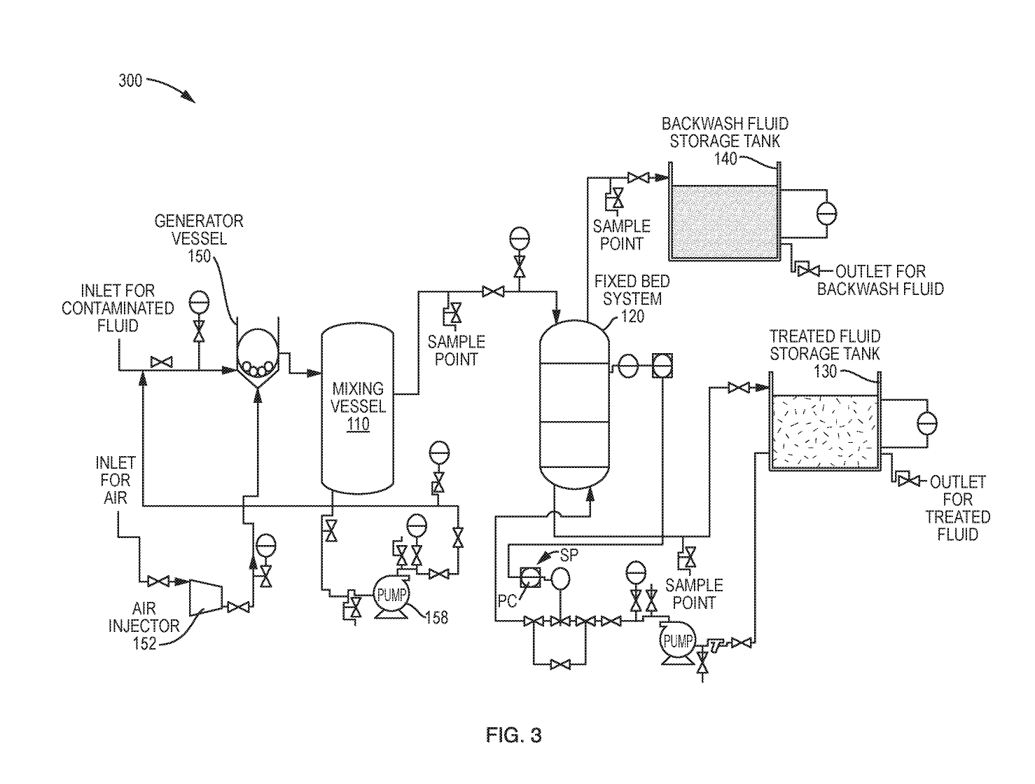

FIG. 3 is a layout diagram of a first embodiment 300 of the example fluid treatment system of FIG. 1, showing, among other things, the generator vessel 150 arranged separate from the mixing vessel 150. In such an example, contaminated fluid (e.g., water) 170 enters the generator vessel 150 where it contacts with corrosion materials, which adsorb the dissolved contaminants. Some adsorption may occur in the generator vessel 150, and the resulting new compounds precipitate and are dragged by the flow of the fluid into the mixing vessel 110. Additional adsorption may occur in the mixing vessel 110, between particulates of corrosion materials that were dragged from the generator vessel 150 and any remaining contaminants in the fluid. Upon outflow from the mixing vessel 110, into the filter bed system 120, the new compounds are filtered out, letting clean fluid (e.g., clean water) pass to the treated fluid storage tank 130.

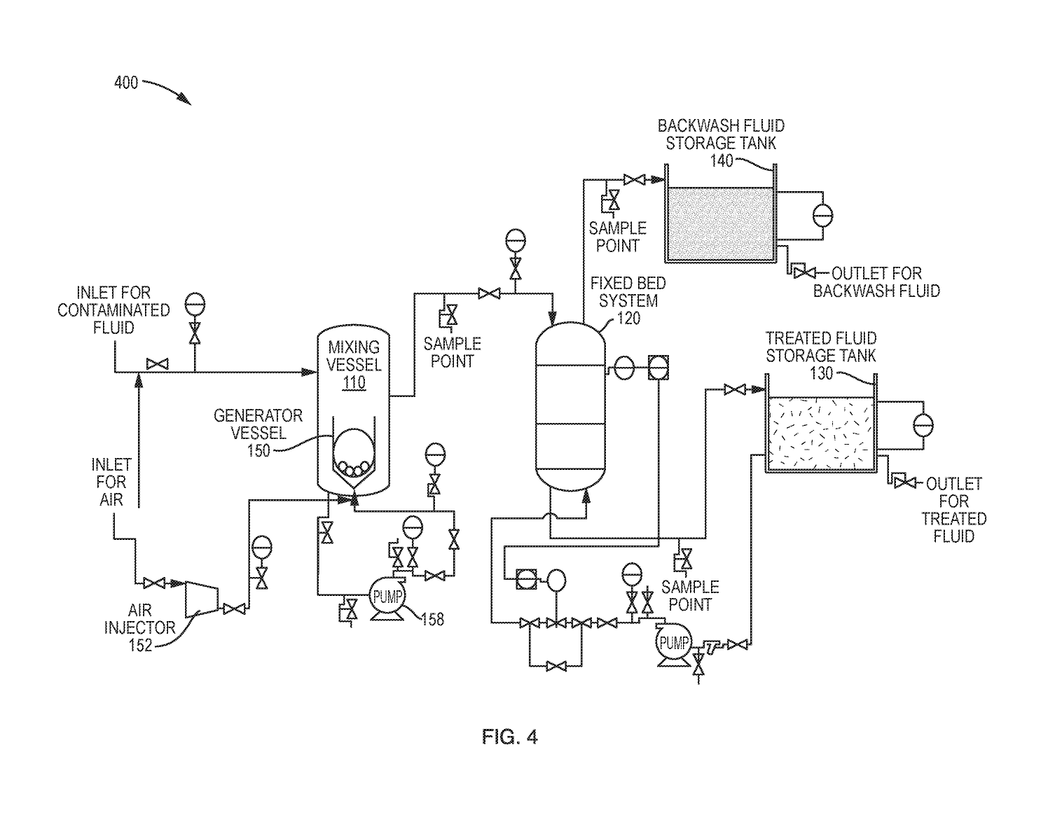

FIG. 4 is a layout diagram of a second embodiment 400 of the example fluid treatment system of FIG. 1, showing, among other things, the generator vessel 150 arranged internal from the mixing vessel 110.

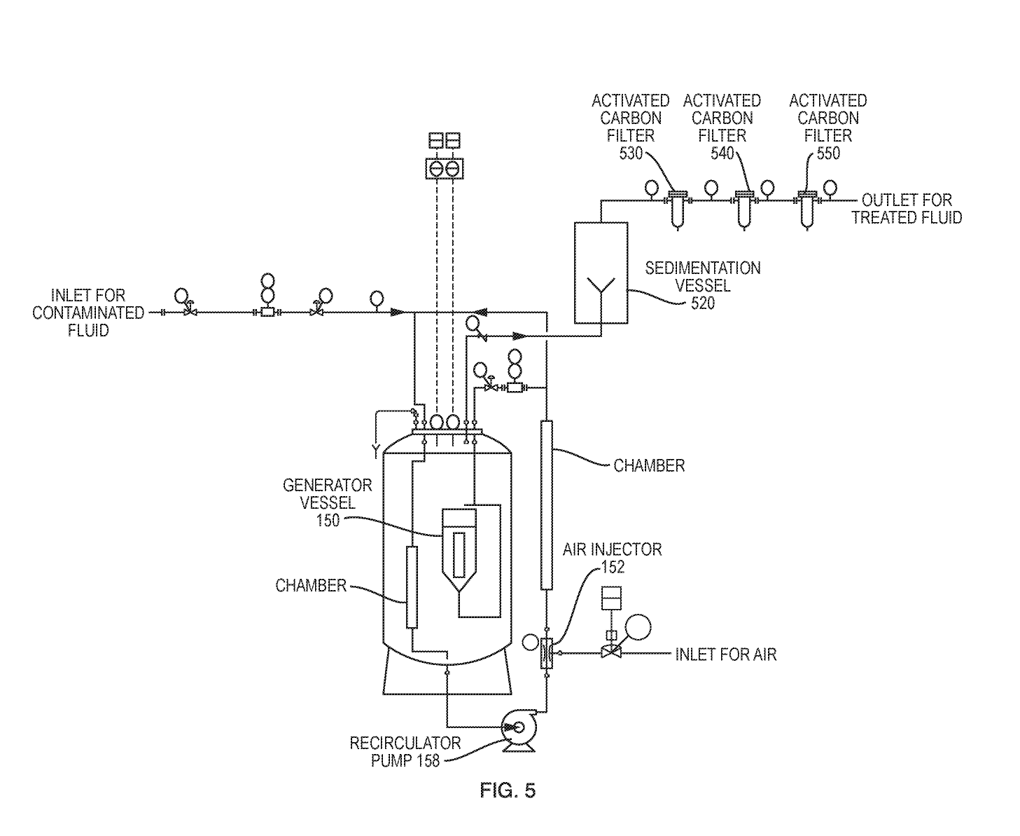

FIG. 5 is a layout diagram of a third embodiment 500 of the example fluid treatment system of FIG. 1, showing, among other things, the generator vessel 150 arranged internal from the mixing vessel 110, and alternative arrangements for the introduction of air and filtration. In such configuration, air may be injected into a fluid supply line 510 leading from the recirculator pump 156 back to the mixing vessel 110. Further, filtration may be performed using a sedimentation vessel 520, a pair of granular activated carbon filters 530, 540 and a manganese filter 550.

### Test Systems of Different Scales

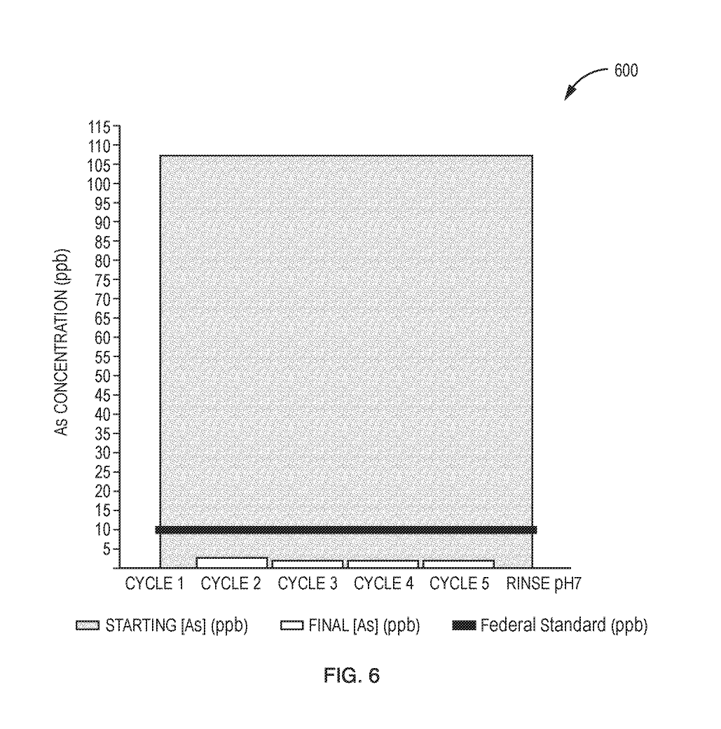

The above describes techniques for removal of contaminants (e.g., arsenic, as well as other dissolved metals, metalloids and non-metals contaminants) from a fluid (e.g., water) involving in-situ generation of filtration media/reactive components have been experimentally tested using systems of different scales. A first, laboratory scale single pass test system (packed-bed filter) was built using the corrosion materials produced with carbon steel spheres of 1.000 degree, ⅛ inch diameter and with a composition of approximately 98% iron, 0.1-0.3% carbon, 0.3-1% manganese, less than 0.045% phosphorus, less than 0.5% sulfur and less than 0.3% silicon. The corrosion materials mentioned above were obtained by mixing 70 milliliters (ml) of deionized water and 16.3 grams of iron spheres in a 100 ml plastic receptacle. The receptacle was placed in a rotator at 30 revolutions per minute (RPM) for 24 hours. A procedure was used to simulate a fixed bed filter system consisting of building a filtration media cake (i.e. layer) with 25 milligrams of corrosion materials. Then, 100 ml of naturally occurring arsenic contaminated well water from a household in New Hampshire was passed through the filtration media cake five times (henceforth referred to as one cycle). The filtration media cake was rinsed with 100 ml of deionized water with a neutral pH after every cycle. After the last cycle, 100 ml of deionized water at a neutral pH, and solutions with pH 4 and pH 12, were passed through the filtration media cake to verify the arsenic particles were irreversibly captured within the filtration media cake (which they were). FIG. 6 is a graph 600 showing experimental results of an example laboratory scale test system, built according to the above description. As can be seen, the arsenic concentration drops from 100 ppb to less than 5 ppb. Such results were achieved in less than 4 minutes.

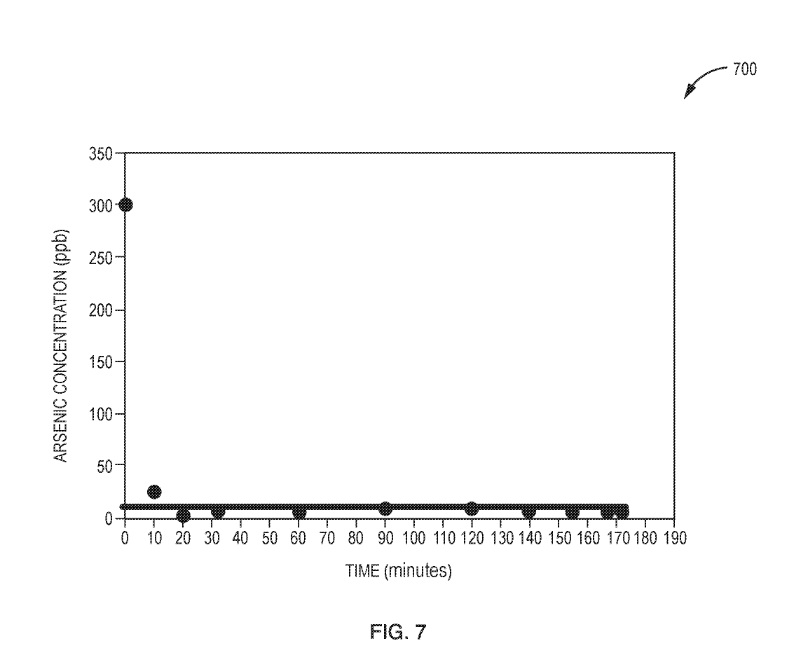

A second, intermediate scale test system was built capable of treating a continuous flow of 0.001 liters per second (L/s) of contaminated fluid. The system utilized corrosion materials produced from carbon steel spheres (as in the above discussed laboratory scale test system), a 9 liter (L) mixing tank, and a faucet filter to simulate a fixed bed filter system. The mixing tank was made of acrylic, and a generator vessel was placed inside. The faucet filter contained coconut shell activated carbon. The preparation of the system consisted of placing the generator vessel containing 121.41 grams (˜970 units) of the carbon steel spheres and 9 L of a synthetic contaminated aqueous solution with a concentration of 300 ppb of arsenic at 30° C. inside the mixing vessel, while injecting airflow of 0.2 L per second for a period of time of 5 to 20 minutes. Testing was performed using a pentavalent arsenate (As(V)) solution at a concentration of 1,000 milligrams (mg)/L and 0.1 molar (M) nitric acid (HNO₃). The synthetic contaminated solution was prepared in the mixing tank by diluting 2.7 mL of As(V) solution in 9 L of potable water. Another contaminated solution was prepared in a 20 L drum diluting 6 mL of As(V) solution in 20 L of potable water. The electrochemical reaction with water and air and the rubbing, collisions and abrasion of the spheres with each other and the equipment internals released sufficient corrosion materials into the contaminated solution to remove the contaminants in a single pass. Testing showed that one sphere generated about 0.728 milligrams of corrosion materials. A continuous flow of contaminated solution passed through the whole system, with the contaminants being adsorbed by the corrosion materials inside the mixing tank. The contaminants and corrosions material were captured in the simulated fixed bed filter system (faucet filter). Testing was conducted to treat 29 L of synthetic contaminated solution. FIG. 7 is a graph 700 showing experimental results of an example intermediate scale test system, built according to the above description. As can be seen, the arsenic concentration drops from 300 ppb to less than 10 ppb in less than 20 minutes and it is kept below 10 ppb for the remainder of the test period.

A third, larger scale test system was built capable of treating a continuous flow of 3.79 liters per minute (L/m) of contaminated fluid. The system used a 60 L mixing vessel and a 28 L fixed bed filter system. The preparation of the system included placing 6.8 kilograms of the carbon steel spheres (having the characteristics discussed above in relation to the laboratory scale system), and 60 L of contaminated aqueous solution inside the mixing vessel while injecting airflow of 0.2 L/s. A continuous flow of contaminated fluid passed through the whole system. The contaminants were captured in a fixed bed filter system containing manganese dioxide, which is backwashed for 25 seconds 3 times per week with clean water. The backwash system was programmed to pump 1.6 L of clean water from a treated water storage tank through the fixed bed filter system in backward flow, leading to a backwash water storage tank.

### Concluding Comments

It should be understood that various adaptations and modifications may be made to the above discussed systems and methods for removing contaminants from a fluid using in-situ generation of filtration media or reactive components. While various ones of the embodiments discussed above involve removing various forms of arsenic, it should be understood that the techniques are applicable to a wide variety of other dissolved metal, metalloid and non-metal contaminants, including aluminum, cadmium, cobalt, chromium, copper, mercury, molybdenum, nickel, lead, antimony, selenium, tin, thallium, uranium, and zinc, among others. Further, while various ones of the embodiments discussed above involve water as the fluid, it should be understood that the techniques are applicable to other types of liquids. Similarly, while it is discussed above that the techniques may be used to produce corrosion materials that function as adsorption filtration media or reactive components, it should be understood they may also produce materials that function as catalysts in the removal of contaminants Still further, it should be understood that systems employing the techniques may be constructed in any of a range of different capacities and sizes, including miniaturized sizes. Such systems may be positioned in any of a variety of locations between a fluid source (e.g., a water source, such as a well, reservoir, etc.) and a site where the fluid (e.g., water) is used. Above all, it should be understood that the above discussed systems and methods are meant to be taken only by way of example, and that the true scope of the invention is to be defined by the following claims.

What is claimed is:

1. A method for removing dissolved contaminants from a contaminated fluid using in-situ generation of adsorption filtration media or reactive components, comprising:
supplying a flow of the contaminated fluid into a generator vessel that contains pieces of an oxidizable source;
injecting air into the generator vessel;
agitating the pieces of the oxidizable source in the generator vessel to cause the pieces to grind against each other to release particulates of corrosion materials from the surface of the pieces into solution with the contaminated fluid and to expose fresh portions of the pieces;
generating corrosion materials within the generator vessel by reacting the particulates of corrosion materials with the contaminated fluid and oxygen from the injected air;
simultaneous to the generating, adsorbing the dissolved contaminants in the contaminated fluid on the corrosion materials to generate particulate compounds;
precipitating the particulate compounds generated by the adsorption of the dissolved contaminates on the corrosion materials; and
filtering the particulate compounds to remove contaminants and yield treated fluid.

2. The method of claim 1, wherein the agitating is performed by magnetic fields operating upon the pieces of the oxidizable source.

3. The method of claim 1, wherein the agitating is performed by a recirculation flow incident upon the pieces of the oxidizable source.

4. The method of claim 1, wherein particulates of corrosion materials released from the pieces of the oxidizable source and the contaminated fluid are maintained in a solution within a mixing vessel by agitation, recirculation, concentration and/or mixing.

5. The method of claim 1, further comprising:
heating the generator vessel.

6. The method of claim 1, wherein the filtering further comprises:
passing the particulate compounds and fluid through a cartridge filter system.

7. The method of claim 1, wherein the filtering further comprises:
passing the particulate compounds and fluid through a fixed bed system; and
periodically refreshing the fixed bed system by creating a backflow to drag particles deposited in the fixed bed system to a backwash water storage tank.

8. The method of claim 1, wherein the dissolved contaminants comprise a form of arsenic.

9. The method of claim 8 wherein the form of arsenic comprises arsenite (As⁺³) or arsenate (As⁺⁵).

10. The method of claim 1, wherein the dissolved contaminants comprise a form of lead, selenium or aluminum.

11. The method of claim 1, wherein the dissolved contaminants comprise at least one contaminant selected from the group consisting of: uranium, mercury, cadmium, nickel, tin, chromium, zinc, cobalt, copper, thallium, molybdenum and antimony.

12. The method of claim 1, wherein the contaminated fluid is contaminated water and the treated fluid is potable water.

13. The method of claim 1, wherein the pieces of the oxidizable source comprise zero-valent iron spheres and the particulates of corrosion materials comprise iron oxide complexes.

14. A system for removing dissolved contaminants from a contaminated fluid using in-situ generation of adsorption filtration media or reactive components, comprising:
a generator vessel configured to receive a flow of the contaminated fluid and pass the contaminated fluid over pieces of an oxidizable source;
an air injector configured to inject air into the generator vessel to promote generation of corrosion materials by reaction of the pieces of the oxidizable source with the contaminated fluid and oxygen from the injected air;
an agitation system configured to cause the pieces of the oxidizable source to grind against each other to release particulates of corrosion materials from the surface of the pieces of the oxidizable source into solution with the contaminated fluid, wherein particulates of corrosion materials adsorb the dissolved contaminants in the contaminated fluid to generate particulate compounds; and
a filtration system configured to filter the particulate compounds to remove the dissolved contaminants and yield treated fluid.

15. The system of claim 14, wherein the agitation system comprises a magnetic field agitation device that uses magnetic fields to move the pieces of the oxidizable source.

16. The system of claim 14, wherein the agitation system comprises a recirculator pump that uses recirculation flow to move the pieces of the oxidizable source.

17. The system of claim 14, further comprising:
a mixing vessel in which the particulates of corrosion materials released from the pieces of corrosion materials and the contaminated fluid are maintained in a solution by agitating, recirculating, concentrating and/or mixing to promote adsorption of the dissolved contaminants.

18. The system of claim 17, wherein the generator vessel is disposed internal to the mixing vessel.

19. The system of claim 14, wherein the filtration system is a cartridge filter system or a fixed bed system.

20. The system of claim 14, wherein the dissolved contaminants comprise a form of arsenic, the contaminated fluid is contaminated water and the treated fluid is potable water, the pieces of the oxidizable source comprise zero-valent iron spheres and the particulates of corrosion materials comprise iron oxide complexes.
